(19) United States
(12) Patent Application Publication
(10) Pub. No.: US 2021/0046515 A1
(43) Pub. Date: Feb. 18, 2021

(54) A SANITARY CLEANING ARRANGEMENT, A KNIFE SHEATH ASSEMBLY AND A METHOD FOR SANITARY CLEANING KNIFES

(71) Applicant: Bon Vivant AS, Søgne (NO)

(72) Inventor: Silje Merethe FOSSNES, Søgne (NO)

(21) Appl. No.: 16/964,063

(22) PCT Filed: Jan. 23, 2019
(86) PCT No.: PCT/EP2019/051566

§ 371 Date: Jul. 22, 2020

(30) Foreign Application Priority Data
Jan. 23, 2018 (NO) 20180104

(51) Int. Cl. B08B 1/00; A47L 17/00; B26B 29/02

(52) U.S. Cl. CPC B08B 1/001; B26B 29/025; A47L 17/00

(57) ABSTRACT

Sanitary cleaning arrangement for knives and sharp-edged objects, comprising an absorbent arrangement comprising a first and a second absorbent module. The first and the second absorbent modules are moisturized with a sanitizing agent and each of the absorbent modules comprises a sanitizing agent supply surface. The absorbent arrangement is configured for installment in an installation position accommodated by a knife sheath assembly. When the absorbent arrangement is arranged in the installation position, the first and second absorbent modules are positioned with the sanitizing agent supply surfaces opposed facing each other and configured for receiving the knife blade in a cleaning position. The absorbent arrangement is arranged for applying the sanitizing agent from the sanitizing agent supply surfaces onto the knife blade, when placing the knife blade in the cleaning position. Method for sanitary cleaning of knives and sharp-edged objects.

The present invention relates to the field of sanitary cleaning of knives and sharp-edged objects.

More specifically, the invention relates to a sanitary cleaning arrangement for knifes and sharp-edged objects, a knife sheath assembly comprising the cleaning arrangement and a method for cleaning knifes and sharp-edged objects.

The present invention also relates to the field of carrying knives or other sharp-edged objects on the body, and in a particular embodiment combining the carrying function with the sanitary cleaning function.

The knives and sharp-edged objects suitable for sanitary cleaning, include knives used in a professional or domestic kitchen, and other knives and sharp-edged objects or even surgical knives and instruments, used by butchers or other personnel in need of these objects. Further sharp-edged objects such as scissors to be used in various environments for instance at a hair dressers salon, may also be suitable for sanitary cleaning in accordance with the invention.

### BACKGROUND

Knives used for chopping and cutting in a professional or domestic kitchen or in an abattoir need cleaning repeatedly in between chopping and cutting tasks. The knives in a professional or commercial kitchen may be available for common use or the personnel may be in possession of their own knives. Especially, knives for common use tend to be neglected and the cleaning of these knifes are often insufficient. Thus, the commonly used knifes within a commercial kitchen are a well-known source for bacterial growth.

As mentioned personnel working in a commercial kitchen, such as professional chefs may own a set of knifes, and some of these knives are used on a frequent basis. The frequent use of certain knives demands the subsequent cleaning of the knives to maintain an adequate sanitary regime as required for commercial kitchens.

It is a challenge within commercial kitchens and domestic kitchens to maintain this sanitary regime, especially when sharing common knives or if in possession of personal knifes and frequently using the same knives, and the time available in between the tasks is restricted. This situation may cause the negligence in the cleaning procedure and in some cases the knives are simply cleaned in running tap water or wiped off, and in worst cases not cleaned at all. A rise of bacterial growth on these kitchen knives, and possibly also an outburst of bacterial disease among the guests having been served food contaminated by unhygienic knifes, are consequences of the neglect of following the proper cleaning routine.

Testing on knifes in commercial kitchens has revealed that especially knives for common use among kitchen personnel, have substantial bacterial growth and is an obvious source of infection.

As such there is a need for providing solutions ensuring that the maintenance of a sanitary regime within a commercial kitchen, a butchery, a hair dressers salon or an environment that needs to be surgical clean or other fields where strict hygienic precautions are required. Alternative areas for such a solution include domestic kitchen or other places where cleaning of a knife is necessary.

A known device for simplifying the cleaning of a knife is shown in U.S. Pat. No. 8,966,702, where a U-shaped sponge cleaning member wipes off both sides of the knife blade simultaneously. A cleaning liquid may be used for enhancing the cleaning effect of the sponge.

JPH08150110 discloses a bendable holding device arranged for receiving two sponge members to be folded around a knife blade to be wiped after cleaning or for applying moisture to a knife blade. The device is especially suitable for children not accustomed to handling knifes.

U.S. Pat. No. 8,356,382 describes a scraper device for loosening and removal of debris sticking to the knife blade.

Known cleaning methods satisfying the set sanitary regime within commercial kitchens follows a cleaning procedure and a subsequent procedure for disinfection. A satisfactory cleaning procedure works as follows; first rinsing the knife using cold water, then washing the knife thoroughly using lukewarm water and an appropriate detergent and then rinsing the knife again using cold water. The knife needs to be dried before the application of a disinfector onto the knife blade. This is a rather cumbersome procedure that necessitates enough available time to ensure that all steps are carried out, and as mentioned previously, lack of available time makes the user skip one or more of these steps.

Or if following a wide spread cleaning method for common knifes; washing the knifes in the dish washer. This method is insufficient as the water seldom hits the knife blade directly, and thus pieces of food are left on the knife blade causing bacterial growth on the knife blade. In addition, the cleaning of knifes in the dishwasher damages the knife blade and the wood of the knife handle.

It is an object of the invention to solve, or at least substantially alleviate, the above-described disadvantages of the prior art cleaning methods and apparatuses.

It is further an object of the present invention to provide a solution for cleaning of a knife or sharp-edged objects that ensures that the set sanitary regime is followed and which also ensures the safe handling of the knife in a hectic environment.

### SUMMARY OF THE INVENTION

The present invention is defined by the attached claims and in the following; The invention provides a sanitary cleaning arrangement for knifes and sharp-edged objects such as instruments and knifes. The sanitary cleaning arrangement comprises an absorbent arrangement comprising a first and a second absorbent module moisturized with a sanitizing agent. Each of the absorbent modules comprises a sanitizing agent supply surface. The absorbent arrangement is configured for installment in an installation position accommodated by a knife sheath assembly. When the absorbent arrangement is arranged in the installation position, the first absorbent module and second absorbent modules are arranged with the sanitizing agent supply surfaces positioned opposed facing each other, such as in a side by side manner, configured for receiving the knife blade in a cleaning position. The cleaning position of the knife blade may be between the sanitizing agent supply surfaces, and if each absorbent module is arranged with a protective layer the cleaning position is arranged between the protective layers. The absorbent arrangement is arranged for applying the sanitizing agent from the sanitizing agent supply surfaces onto the knife blade, when placing the knife blade in the cleaning position.

The invention further provides a method for sanitary cleaning knifes and sharp-edged objects by means of an absorbent arrangement comprising a first and a second absorbent module moisturized with a sanitizing agent. The first and the second absorbent modules are accommodated in an installation position by a knife sheath assembly. The sanitizing agent supply surfaces of the first and a second absorbent module are positioned opposed facing each other, wherein the method comprises the following steps:
guiding a first portion of the blade of a knife or a sharp-edged objects into an insert area of the absorbent arrangement,
directing the knife blade further into the insert area receiving the knife blade in a cleaning position between the sanitizing agent supply surfaces thereby applying the sanitizing agent released from the sanitizing agent supply surfaces onto the knife blade.

The invention advantageously provides a solution to ensure that the knife (kitchen knife, butchers knife or other sharp-edged object such as scissors needing cleaning) is properly sanitized or disinfected. Bacterial testing of knifes on rotation in between chefs in a commercial kitchen and stored on a magnetic rack, often show high amounts of bacteria. After being treated by the sanitary cleaning in accordance with the invention these knives show a low occurrence of bacteria, and in some circumstances even no bacteria.

The step of sanitizing or disinfecting as provided by the inventive cleaning arrangement, is to be carried out after a thorough cleaning using hot water and a detergent, and the knife or sharp-edged object should preferably assume a dry state before the sanitizing is performed. For the proper working of the invention, visible pieces of food or other debris should be removed from the knife or sharp-edged object by wiping, rinsing or washing, and it is mandatory that the knife or sharp-edged objects are visually clean before the sanitizing. However, it may happen that the professional working in a commercial kitchen or butchery in a stressed situation does not follow this procedure, and in exceptional circumstances the invention may be employed without the prior water and detergent cleaning.

The sanitizing agent may comprise a disinfectant for instance anti-bacterial liquid such as ethanol or a spirit, or alternatively a suitable material, liquid or component. The sanitizing agent may be applied to the first and a second absorbent module for moisturizing of the absorbent modules, before placing the absorbent arrangement in the installation position. The absorbent modules may be moisturized by the user before being placed in the installation position, or may be pre-moisturized during manufacturing and as such are ready to use and prepared for easy installment into the installation position.

However, the sanitizing agent may also be supplied to the absorbent arrangement when in installed position. Various factors need to be taken into account when choosing type and dosage of a sanitizing agent, such as the working time of the sanitizing agent and evaporation rate of the sanitizing agent. Due to high pace in most commercial kitchens, the knife might not be kept long in cleaning position before it is withdrawn for further use in the kitchen.

As such a sanitizing agent containing a high percentage of alcohol such as ethanol may be preferred. A sanitizing agent having a high percentage of alcohol has the advantage that the evaporation rate is high, and there is no need to dry the knife blade after the cleaning has taken place. The retention time in the cleaning position may not always match the recommended working time for the sanitizing agent, but will still have the effect of ensuring that the amounts of bacteria and viruses are kept at an acceptable level. The sanitizing agent may be an alcohol based liquid or other suitable liquid or a mixture of liquids or components suitable for extermination of bacteria, and if needed for extermination of viruses.

The dosage of the sanitizing agent is estimated to ensure that the whole knife blade is covered and the absorbent modules should be provided ensuring the capability of absorbing liquid and storing the liquid until the later application of the sanitizing agent on to the knife blade in the cleaning position.

One or both the absorbent modules may comprise various elements such as absorbent pads composed of a single sponge material, or other absorbing material, or a layered assembly of materials with varying absorbing characteristics. The absorbent module may also be made of a fabric. For instance, one fabric all through the absorbent module or one or plural type of fabrics layered for building up the absorbent modules. As the skilled person will realize; various kind of materials may be used for making the modules displaying absorbent qualities. In one aspect, the absorbent module may be made of a gel material, either as a part of the absorbent module or the whole absorbent module. A further alternative for manufacture of the absorbent modules are absorbent granulates. The absorbent module may then comprise absorbent granulates such as small sized balls, pellets or other fragmented particles made of a material capable of soaking up, storing and releasing liquid. These absorbing granulates may be enclosed by a wrap up or envelope for keeping the absorbent granulates in place. Protective layers arranged to cover portions of the sanitizing agent supply surfaces may comprise the wrap up or envelope.

The absorbent modules each comprises a sanitizing agent supply surface for the release of the sanitizing agent when the knife blade is arranged in the cleaning position. The absorbent modules may be positioned so that the absorbent modules are arranged in contact with the knife blade all along the knife blade in the cleaning position. This contact between the knife blade and the absorbent modules, ensures an even distribution of the sanitizing agent onto the knife blade. The absorbent modules may preferably be arranged resilient or elastic for receiving knife blades of various thickness. Upon receiving the knife blade in the cleaning position, the absorbent modules are compressed, and the subsequent force resulting from this compression engages the absorbent modules in contact with the knife blade. The degree of compression of the absorbent modules, and the contact force established in the contact between the absorbent modules and the knife blade, depends on the of thickness the knife blade. However, the absorbent modules are arranged to ensure sufficient contact between knife blade and the absorbent modules for the even distribution of the sanitizing agent for knife blades and sharp-edged objects of various thickness.

The sanitizing agent is applied to the knife blade due to contact with the absorbent modules. If the absorbent modules are compressed due to the thickness of the knife blade, or the gap distance between the absorbent modules in the installation position is narrow (the absorbent modules may even be positioned in contact with each other), these circumstances effect the release of the amount of sanitizing agent on to the knife blade. The increased amount of sanitizing agent occurs due to resulting compression forces squeezing the absorbent modules, when introducing the knife blade into the cleaning position.

The absorbent modules may be disposable or may alternatively be of a more permanent kind for repeated use, one or plural times. Both kinds will be moisturized before installment in the installation position or may even be moisturized in the installation position by a suitable liquid or component. The disposable absorbent modules will be thrown away after use, while the permanent version needs a retreatment of the sanitizing agent before being arranged in the installation position again ready for use, or alternatively the sanitizing agent is supplied to the absorbent modules in the installed position. The permanent version of the absorbent module may be washed before further use.

When the absorbent arrangement is arranged in the installation position accommodated by a knife sheath assembly, the first absorbent module and second absorbent module are arranged side by side with the sanitizing agent supply surfaces positioned opposed facing each other. To obtain this installation position of the first absorbent module and second absorbent module, the absorbent modules may be prepared as separate modules for installment in the installation position. However, the first absorbent module and second absorbent modules may alternatively be part of a one-piece assembly, which may be configured with the sanitizing agent supply surfaces positioned opposed facing each other when arranged in the installation position.

The absorbent arrangement may be releasably accommodated in the installment position and may be arranged for retrieval when necessary, for replacing the first absorbent module and second absorbent modules.

The absorbent arrangement may further comprise a protective layer covering at least a portion of the opposing facing surfaces of the first absorbent module and second absorbent module. The protective layer has the advantage of preventing the possible damage inflicted from the knife blade when engaging in contact with the sanitizing agent supply surfaces. The protective layer may be provided as a separate element arranged superposing the sanitizing agent supply surface, either connected to the underlying the sanitizing agent supply surface or just positioned onto the sanitizing agent supply surface. Alternatively, the protective layer may be arranged as an integrated part of the first absorbent module and/or the second absorbent module.

When the first absorbent module and/or second absorbent module comprises the protective layer, the absorbent arrangement is provided so that the ability of the sanitizing agent supply surface to release sanitizing agent for the cleaning of the knife blade is kept intact.

In an embodiment of the invention, the protective layer may have a perforated configuration for allowing the release of sanitizing agent through the protective layer. The sanitizing agent flows through the perforations due to the capillary effect. The protective layer may be arranged with a plurality of through holes leading the sanitizing agent from the sanitizing agent supply surface to the knife blade in the cleaning position. When the absorbent arrangement has no protective layers arranged on the absorbent modules, the knife blade is arranged in direct contact with the sanitizing agent supply surfaces of the absorbent modules when inserted into the cleaning position. In the embodiment where the protective layers cover parts or the whole of the sanitizing agent supply surfaces, the knife blade is arranged in contact with the protective layers in the cleaning position. The sanitizing agent passes from the sanitizing agent supply surface and through the protective layer for application of the sanitizing agent on the knife blade. In the case where the protective layers are perforated, the sanitizing agent passes through the perforations of the protective layers by capillary action and by the compression forces as exerted by the knife upon entrance, for dosage of the sanitizing agent on the knife blade. As an alternative to the perforated configuration, the protective layers may be arranged otherwise for transport of the sanitizing agent through the protective layers, for instance by arranging the protective layers permeable.

In addition to the protective layers being arranged on the sanitizing agent supply surfaces, support layers may also cover outer surfaces of the first absorbent module and second absorbent modules. The support layers may be arranged on opposite sides of the first and second absorbent module respectively, and each absorbent module may appear as a sandwich structure where the absorbent module is arranged as the mid layer and the protective layer and support layers are arranged as outer layers. The arrangement of protective layers, support layers and absorbent module may be provided as a continuous entity or separate elements.

To facilitate the replacement of the absorbent arrangement, the first and second absorbent module may each be arranged with support and protective layers provided as a unit that is easy to insert into installation position. This unit which may for instance be arranged as a cassette may be provided as a disposable unit for repeated used. The cassette may preferably be sealed up to protect its contents and prevent the evaporation of the sanitizing agent. A tear-up, for instance by removing a tape or other similar solution, may be used for immediate access to the content of the unit or cassette. Alternatively, the absorbent arrangement may comprise a hard pack solution or a storage bag made of a plastic material or other material capable of preventing the evaporation of the sanitizing agent from the first absorbent module and second absorbent module. By this arrangement, contact between the interior of the knife sheath assembly and knife and sanitizing agent respectively, is prevented. Thus, thorough cleaning of the interior of the knife sheath assembly is not always necessary; rinsing, wipe off or washing in the dish washer may be chosen according to need. When installing the absorbent arrangement including the storage bag in the installation position, the insert of the knife blade into the cleaning position may break the storage bag open, and the absorbent modules are then ready for use. Alternatively, the storage bag may be opened or even removed before inserting the knife into the installation position, for instance by a tear up solution breaking the sealing.

The absorbent arrangement is arranged to be accommodated by a knife sheath assembly manufactured to endure both dry and moist content. The knife sheath assembly may be produced in various shapes and sizes. The interior of the knife sheath assembly may endure both water and alcohol, as well as varying temperatures from −30° C. to 50° C., and is also capable of enduring impacts. The knife sheath assembly may comprise a receptacle sheath member for holding knifes and sharp-edged objects for instance a pair of scissors, and a sanitary cleaning arrangement as defined and explained above. The absorbent arrangement may be accommodated by the receptacle sheath member in the installation position. The receptacle sheath member may comprise a housing for supportive accommodation of the absorbent arrangement in the installation position, for instance as defined by inner walls of the receptacle sheath member. Alternatively, the absorbent arrangement is configured attachable to an exterior portion of the knife sheath.

Prior art solutions have not made it possible for the chefs to carry the knife on the body, due to the risk of contaminating the knife with bacteria. The possibility of integrating the absorbent arrangement for sanitizing the knife into the knife sheath assembly, makes it possible to carry the knife on the body without the aforementioned risk of spreading bacteria to the knife.

The knife sheath assembly may further comprise a scraper device. The scraper device may be arranged for wiping off excess of sanitizing agent when withdrawing the knife from the knife sheath assembly. The scraper device may be configured to prevent or slow down the vaporization of sanitizing agent present in the receptacle sheath member, and will also guide the knife blade into installation position when entering the receptacle sheath member.

The knife blade needs to be visually clean before entering the knife sheath assembly. Depending on the state of knife it should be wiped off, rinsed, washed etc or may not need cleaning at all, but should be verified visually clean before entering the knife sheath assembly. Should the knife blade by neglect still contain debris, the scraper device will remove these debris from the knife blade as a safety measure. The scraper device also has the additional advantage of being capable of wiping off excess of water from the knife blade, before entering the knife sheath assembly. Even if standard procedure is that the knife blade should be clean and dry before being inserted into the knife sheath assembly, this additional function of the scraper device covers deviations from standard procedure.

The knife sheath assembly may further comprise a lid member which may be releasably attached to the receptacle sheath-member and may also be arranged with a knife opening for inserting the knife blade into the cleaning position. The scraper device may be accommodated in the lid member, and configured for engagement with the knife blade when entering through the knife opening. The lid member may replaced if worn out, or for other reasons, by another lid member.

The scraper device may have various configurations and may in one embodiment comprise two scraper elements accommodated in the lid member. Alternatively, the scraper device may comprise one scraper element or more than two scraper elements. When the scraper device comprises two scraper elements, it may be arranged in a position for engagement with the knife blade, when entering and withdrawing the knife blade from the cleaning position. The two scraper elements may advantageously have an installed position where a tip portion of each of the scraper elements are arranged in contact with each other, to reduce and in best case avoid vaporizing of sanitizing agent past the scraper elements. The scraper elements may be arranged as resilient members for instance as squeegees, or other compliant or elastic elements that yield in contact with the knife blade when inserting the knife blade, for wiping and restoring its shape after the knife is withdrawn. When withdrawing the knife from the cleaning position, some of the sanitizing agent will follow the knife blade and be deposited on the scraper device and the lid member. This depositing of sanitizing agent has a sanitizing effect preventing bacterial growth on the scraper device and the lid member. The scraper device may be arranged replaceable. The scraper elements may have various configurations, the cross section of each scraper element may for instance be arranged uniform along the length of the scraper element or may be arranged pointed towards its tip portion.

Due to this deposit of sanitizing agent, the occurrence of bacteria might be kept within an acceptable range and further cleaning may not be necessary. In most cases, a daily routine would include wiping off or rinsing the lid member at the end of a work shift. If the lid member is visually clean, further washing is not necessary. However, if further cleaning is needed, the lid member should be cleaned using hot water and possibly a detergent. The lid member could also be cleaned in the dish washer or by other suitable cleaning methods.

The knife sheath assembly may comprise an attachment piece for selective suspension of the receptacle sheath member from a user, a wall, furnishing or other suitable places for hanging the receptacle sheath member. The attachment piece may be arranged as a hook member to be fastened to a belt or at other suitable places. The attachment piece may then be arranged as a fixed part of the knife sheath assembly. The attachment piece may also be arranged releasably connected to the receptacle sheath member. The releasable connection may be provided by using fastening means arranged for rapid release and connection of the receptacle sheath member by means of click or snap connection. In addition, the detachable attachment piece may be configured for allowing a slack of the receptacle sheath member, in the event the receptacle sheath member bumps into a piece of the furniture or otherwise is exposed to an impact force. To render the slack possible, the attachment piece and the receptacle sheath member may both be arranged to provide for the possibility of relative, but restricted revolving movement between the receptacle sheath member and the detachable attachment piece. This may be achieved for instance by configuring the detachable attachment piece with an enlarged portion fitting into a recess of the receptacle sheath member. The enlarged portion may then function as a revolving center in the case of a sudden impact, and also to ensure comfort for the user during use.

When inserting the knife blade into the cleaning position, the knife blade is initially guided into an insert area of the of the absorbent arrangement. The insert area may be configured by chamfered portions of the absorbent arrangement forming a knife inlet for easing the arrangement of the knife blade into the cleaning position. If the knife sheath assembly includes a lid member with a knife opening, the knife blade may be inserted through the opening and into the insert area formed as a knife inlet, where inclined surfaces of the chamfered portions direct the knife blade further into the insert area (knife inlet) for receiving the knife blade in the cleaning position. In addition, the lid member may be arranged with a protective structure for guiding the knife blade safely into the knife inlet. The protective structure guides the knife blade safely, even if the user inserts the knife blade into the knife sheath assembly, without the user having the eyes on the knife, for instance if the knife sheath assembly is positioned at the side part of the torso or close to the users back portion.

The lid member may be arranged with additional locking means for securing the knife in the knife sheath assembly, and to ensure that unauthorized removal from the knife sheath assembly does not take place. For instance, to ensure that the knife is not removed from the knife sheath assembly when positioned on the users back. The locking means may easily be operated by the user for releasing the knife from the knife sheath assembly.

All parts of the knife sheath assembly (lid member, scraper device, absorbent arrangement when manufactured reusable and other components making up the knife sheath assembly) are manufactured to endure cleaning for instance by wiping off, rinsing, by water and detergent or in a dish washer.

The oppositely arranged sanitizing agent supply surfaces may be arranged with or without the protective layers. Usually the oppositely arranged sanitizing agent supply surfaces are covered with protective layers which may be arranged in contact with each other before receiving the knife blade. The protective layers may also be arranged with a gap distance to each other, however the gap distance should be estimated to allow the entrance of knife blades of various thickness. The entrance of the knife blade may cause the protective layers to move away from each other, and thereby compress the absorbent arrangement to release the sanitizing agent onto the knife blade. If the sanitizing agent supply surfaces have no protective layers, the oppositely arranged sanitizing agent supply surfaces may be arranged in contact with each other or with a gap distance between the sanitizing agent supply surfaces. Depending on this distance and the thickness of the knife blade, moving the knife blade into the cleaning position might compress the absorbent arrangement, and thereby release the sanitizing agent onto the knife blade. If the protective layer has a perforated configuration, the sanitizing agent is supplied through the protective layer by capillary action.

The knife blade is usually thicker when moving closer to the knife handle and is more slender when moving closer to the tip of the knife blade. When the knife blade is fully accommodated in the cleaning position in between the absorbent modules, the absorbent modules are arranged in engagement with the knife blade ensuring contact all along the knife blade, including the regions closer to the knife handle and the knife tip where the thickness varies. This contact between the absorbent modules and the knife blade ensures an even distribution of the sanitizing agent onto the knife blade. The absorbent modules are resilient/soft and compliant when inserting the knife blade, and follows the outline of the knife from the tip of the knife blade to the broader portion of the knife blade close to the handle.

Plural knife sheath assemblies may be attached to each other to form a system of knife sheath assemblies for instance arranged in a serial engagement. The knife sheath assemblies may be connected to each other by suitable connecting members ensuring a secure connection for easy engagement and disengagement between the knife sheath assemblies included in the system. Knife sheath assemblies of equal sizes may be connected, or a knife sheath assembly of a smaller size may be connected to a larger sized knife sheath assembly. The smaller sized knife sheath assembly may be prepared for housing a smaller knife or a paring knife.

The knife sheath assembly may also be provided for receiving additional equipment for instance a hone.

### BRIEF DESCRIPTION OF THE DRAWINGS

FIG. 1 is a schematic front view of the exterior of a knife sheath assembly holding a sanitary cleaning arrangement.

FIG. 2 is a schematic side view of the knife sheath assembly as illustrated in FIG. 1.

FIG. 3. is a lengthwise cross section of the knife sheath assembly along section line A-A as illustrated in FIG. 1.

FIG. 4 shows a detail of the illustration C in FIG. 3.

FIG. 5 shows a top view of the knife sheath assembly as shown in FIG. 1.

FIG. 6 shows a cross along section lines D-D as illustrated in FIG. 2.

FIG. 7 shows a perspective view of the knife sheath assembly as shown in FIG. 1.

FIG. 8 shows a lengthwise section of the knife sheath assembly along the section lines E-E.

FIG. 9 shows an attachment piece for attachment of a receptacle sheath member.

FIG. 10 shows the attachment of a receptacle sheath member to a belt by means of the attachment piece of FIG. 9.

A knife sheath assembly 1 is shown in the figs. The sheath assembly 1 comprises a receptacle sheath member 2. The receptacle sheath member 2 accommodates a first absorbent module 3 and a second absorbent module 4, which both are moisturized with a sanitizing agent. The first absorbent module 3 and a second absorbent module 4 illustrated in the figs, each comprises a pad element such as a sponge material or other absorbent materials. Materials capable of absorbing liquid and storing the liquid until the later release of the liquid due to for instance compression force squeezing the material, may be used for manufacture of the absorbent modules 3,4.

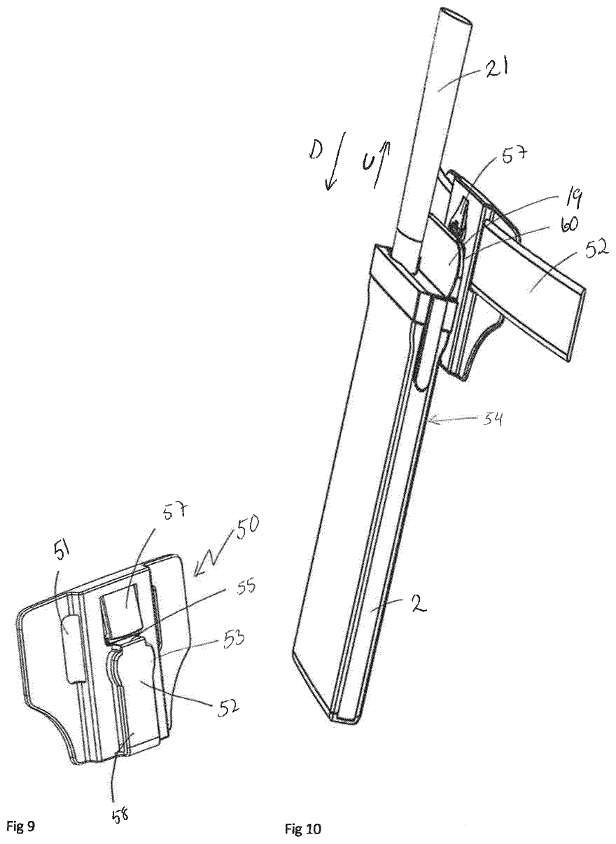

The first absorbent module 3 and the second absorbent module 4 have sanitizing agent supply surfaces 5, 6. When arranged in the accommodated position in the knife sheath assembly as shown for instance in FIG. 3 and FIG. 4, the sanitizing agent supply surfaces 5, 6 are positioned opposed facing each other. Protective layers 7, 8 cover the sanitizing agent supply surfaces 5, 6 respectively, and are shown also covering chamfered portions 9, 10 of the first absorbent module 3 and the second absorbent module 4. The chamfered portions 9, 10 are configured to form an insert area of the absorbent arrangement, such as a knife inlet 13 for guiding and directing the knife blade and receiving the knife blade in a cleaning position as shown in FIG. 8. In the embodiment shown in the figs support layers 11, 12 cover outer surfaces of the first absorbent module 3 and second absorbent modules 4.

The protective and support layers 7, 8, 11, 12 as shown in figs, may be provided as separate parts such as armoring layers or may be integrated as part of the first absorbent module 3 and the second absorbent module 4. The protective layers cover the sanitizing agent supply surfaces 5, 6 and are arranged perforated as shown in FIG. 8. When installing a knife blade into the knife sheath assembly 1 by entrance through the knife inlet 13, the knife blade is inserted in an insert area in between the first and second absorbent module 3, 4. As illustrated in the figs, the gap distance between the absorbent modules 3, 4 is minor or even absent. This gap distance may vary in accordance with need, and the absorbent modules 3, 4 might be arranged distanced apart or the absorbent modules 3, 4 may be positioned so that at least portions of the absorbent modules 3, 4 are arranged in contact with each other. By the insert of the knife blade 20 into cleaning position as illustrated in FIG. 8, the sanitizing agent is applied from the first absorbent module 3 and the second absorbent module 4, through the perforations in the protective layers 7, 8 and onto the knife blade 20.

The protective layers 7, 8 covering the first and second absorbent module 3, 4 prevent the knife blade from damaging the first and second absorbent module 3, 4.

The receptacle sheath member 2 is configured for accommodation of the first and second absorbent module 3, 4 in a supportive manner and apart from a top portion 14, the receptacle sheath member 2 is configured as a closed structure with an insert cavity housing the absorbent modules 3, 4 in a supportive manner.

A lid member 15 is attached to the top portion 14 of the receptacle sheath member. The lid member 15 has locking members 17 such as locking grips fitting into corresponding locking slots provided in the receptacle sheath member 2, thereby facilitating a simple method for attaching and detaching the lid member from engagement with the receptacle sheath member 2. The lid member 15 has a knife opening 16 for the insert of the knife blade. FIGS. 4 and 5 show the knife opening 16 configured as a slit, and an additional opening 17 is provided for receiving the lower portion of the knife handle 21. When inserting the knife blade into cleaning position as shown in FIG. 8, an excess of sanitizing agent is brought to the top portion of the receptacle sheath member 2 and will clean the lower end portion 22 of the knife handle proximate to the knife blade. This part of the knife is often neglected and thus a breeding ground for bacterial growth.

The knife opening 16 of the lid member 15 has a funnel shaped inlet region 23 shaped by inclined surfaces 18, 25 for directing the knife blade 20 safely into the cleaning position as illustrated in FIG. 8.

In addition, a protective structure 19 projects as an extension from the inclined surface 18 to offer further protection, when the user positions the knife into the knife sheath assembly. The protective structure 19 projects from the inclined surface 18 that will be positioned closest to the torso of the user when attached to a belt or other part of the clothing by means of attachment piece 30. As the insert of the knife blade into the knife sheath assembly 1 sometimes happens without the user having the eyes on the knife, the presence of protective and guiding structures is important to avoid bodily injury.

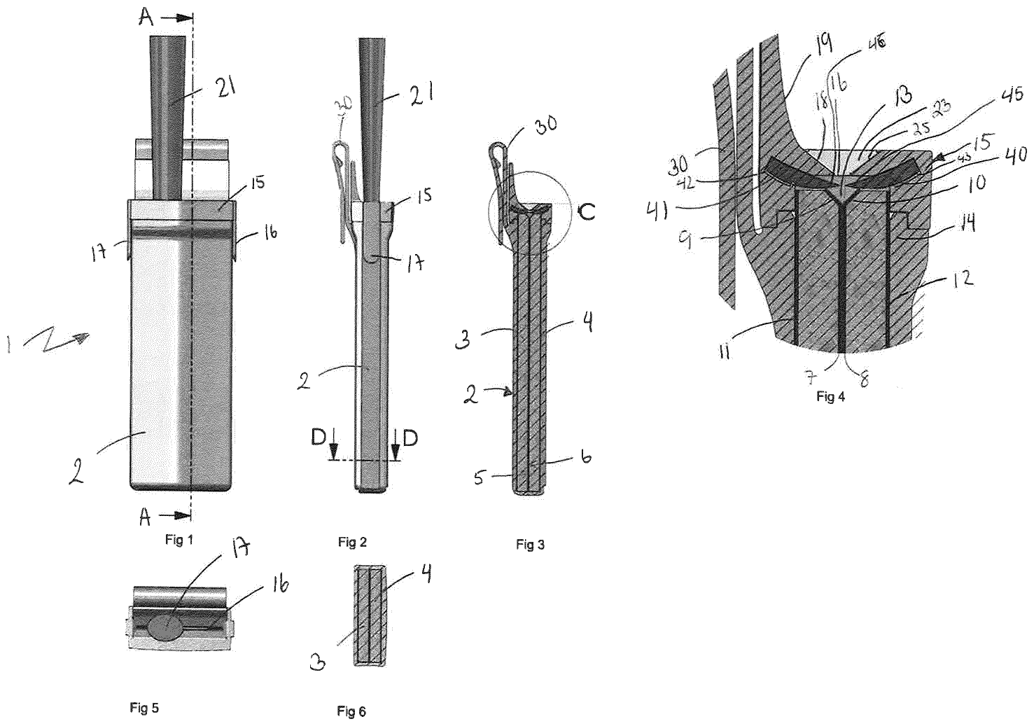

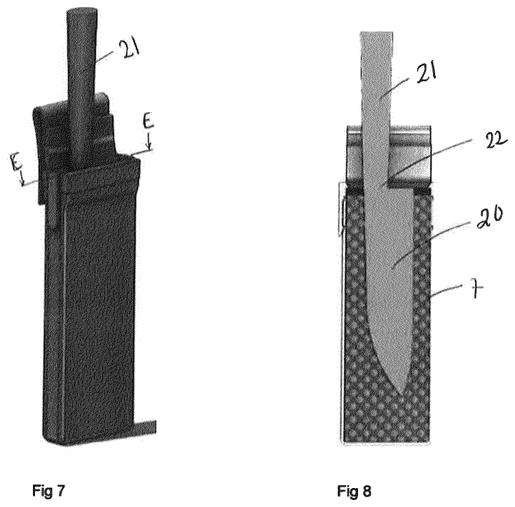

The attachment piece 30 as shown in the FIGS. 1-8 is shown as a hook member to be fastened to a belt, but might also be fastened to a wall, a piece of furniture or other suitable places. The attachment piece 30 as shown in the FIGS. 1-8 is a fixed part of the knife sheath assembly, but it may also be arranged releasably connected to the receptacle sheath member 2 as shown by embodiment on FIG. 9-10. A detachable attachment piece 50 as shown in FIG. 9 has an opening 51 for receiving the belt 52, and may have a click or snap connection or other quick fastening means for rapid simple fastening and release of the receptacle sheath-member 2. In FIGS. 9 and 10 click/snap connection is provided by a resilient locking member 57.

The detachable attachment piece 50 has a positioning and connecting element 52 with an enlarged portion 53 fitting into a lengthwise receiving recess (not shown) arranged on the back portion 60 of the protective structure 19, or alternatively on the back portion 54 of the receptacle sheath member 2. The receiving recess has an open lower portion, two side walls and an upper rim edge closing the top portion of the receiving recess. The width of the enlarged portion 53 corresponds to the inner with of the receiving recess. When the receptacle sheath member 2 is to be connected to the detachable attachment piece 50, the receiving recess of the receptacle sheath member 2 is aligned and guided onto the positioning and connecting element 52 in a downward direction D (seen from the point of the user wearing the belt) as illustrated in FIG. 10, until an upper portion 55 of the positioning and connecting element 52 is brought into engaging contact with the upper rim of the receiving recess. During the connection, the resilient locking member 57 is forced inwards and then returns to its original position again as shown in FIGS. 9 and 10, after the connection between the positioning and connecting element 52 and the receiving recess is completed. The receptacle sheath member 2 then hangs off the upper portion 55 with the width of the enlarged portion 53 fitting correspondingly into the width of the receiving recess. As the positioning and connecting element 52 also comprises a lower portion having a width that is smaller than the width of the receiving recess, the connection between the receptacle sheath member 2 and the detachable attachment piece 50 allows for a slack and possibility for relative, but restricted revolving movement between the receptacle sheath member 2 and the detachable attachment piece 50 with the enlarged portion 53 as a revolving center. When releasing the connection between the receptacle sheath member 2 and the detachable attachment piece 50, the resilient locking member 57 is pushed inwards and the connection may be freely released by moving the receptacle sheath member 2 in an upwards direction U as illustrated (seen from the point of the user wearing the belt) and may have a click or snap connection or other quick fastening means for rapid simple fastening and release of the receptacle sheath-member 2.

The lid member 15 is arranged with a scraper device for wiping off excess of sanitizing agent when withdrawing the knife from the knife sheath assembly. The scraper device also prevents or slow down the vaporization of sanitizing agent from the receptacle sheath member. The scraping device as shown in FIGS. 3 and 4, comprises two scraper elements 40, 41 each having an accommodation portion attached in a corresponding recess in the lid member 15, and a scraping portion 44, 45 positioned to engage with the knife blade 20, when entering and leaving the knife opening 23 into and from the cleaning position. The scraping portions 44, 45 which in the figs are shown as the tip portions of the scraper elements are shown with an installed position where these tip portions are distanced from each other. However, these tip portions may advantageously be arranged in contact with each other to reduce and in best case, avoid vaporizing of sanitizing agent past the scraper elements.

The scraper elements 40, 41 may be arranged as resilient members for instance as squeegees. The scraper elements 40, 41 have an accommodation portion 42 received in a recess 43, and a resilient portion 45 protruding into a position where the knife blade engages with the resilient portions 45 of both scraper elements 40, 41, when entering and when being withdrawn from the cleaning position. Should the knife blade by neglect be contaminated by debris or be wet, the scraper elements 40, 41 is, as a safety measure, capable of removing debris and water before inserting the knife blade into the cleaning position between the first and second absorbent modules 3, 4. When withdrawing the knife from the cleaning position, the scraper elements 40, 41 will wipe off the sanitizing agent. Some of the sanitizing agent will follow the knife blade 20 and be deposited on the scraping portion 44, 45, and will thereby clean the scraper elements 40, 41 and the lid member 15. This is advantageous as the depositing of the sanitizing agent ensures that these elements are kept clean and reduce, and in some circumstances, even eliminate the possibility for bacterial growth on the scraper elements 40, 41.

The depositing of sanitizing agent ensures a satisfactory cleaning of the lid member 15 and the scraper elements 40, 41 during working hours. A simple wipe off of the lid member 15 at the end of the work shift would mostly be sufficient, and in some cases it might be necessary to wash the lid member using hot water and a detergent.

The absorbent arrangement, comprising the first absorbent module 3 and a second absorbent module 4 arranged with the protective and support layers 7, 8, 11, 12, are releasably accommodated in the installment position in the receptacle sheath-member 2, and may be replaced by a new, clean absorbent arrangement by removing the lid member 15 and releasing the existing the absorbent arrangement.

To facilitate the replacement of the absorbent arrangement, the first absorbent module 3 and second absorbent module 4 with the protective layers may be arranged as a unit easy to insert into the receptacle sheath member 2. The absorbent arrangement may then comprise a storage bag (not shown) made of a plastic material or other material capable of preventing the evaporation of the sanitizing agent that soaks the first absorbent module 3 and second absorbent module 4. Alternatively, the absorbent arrangement may be sealed otherwise, for instance by a tear-up tape solution capable of providing rapid access to the absorbent arrangement when needed. When the new absorbent arrangement is placed in the installation position in the receptacle sheath-member 2, the removal of the tape or the insert of the knife blade from the knife inlet and further into the cleaning position, breaks the storage bag open and the absorbent modules 3, 4 are ready for use.

The first absorbent module 3 and second absorbent module 4 may be provided by various materials and in various configurations. The first absorbent module 3 and second absorbent module 4 as shown are made as pads of absorbent materials for instance a sponge material or a cotton material. However, the absorbent modules may alternatively comprise gel, fabrics layered or as a single unit, absorbent granulates such as small sized balls, pellets or other fragmented particles made of a material capable of soaking up, storing and releasing liquid. The absorbent granulates may be enclosed by a wrap up or envelope for keeping the absorbent granulates in place. The protective layers may comprise the wrap up or envelope.

In the preceding descriptions, various aspects of sanitary cleaning arrangement and method for sanitary cleaning according to the invention have been described with reference to the illustrative embodiment. However, this description is not intended to be construed in a limiting sense. Various modifications and variations of the illustrated embodiment, as well as other embodiments of the arrangement, which are apparent to persons skilled in the art, are deemed to lie within the scope of the present invention as defined by the following claims.

1. A sanitary cleaning arrangement for knifes and sharp-edged objects comprising:
an absorbent arrangement comprising a first and a second absorbent module moisturized with a sanitizing agent and each of the absorbent modules comprises a sanitizing agent supply surface,
the absorbent arrangement is configured for installment in an installation position accommodated by a knife sheath assembly, and
when the absorbent arrangement is arranged in the installation position, the first absorbent module and second absorbent module are positioned with the sanitizing agent supply surfaces opposed facing each other and configured for receiving the knife blade in a cleaning position, wherein the absorbent arrangement is arranged for applying the sanitizing agent from the sanitizing agent supply surfaces onto the knife blade when placing the knife blade in the cleaning position.

2. The sanitary cleaning arrangement for knifes and sharp-edged objects in accordance with claim 1,
wherein the absorbent arrangement is releasably accommodated in the installation position.

3. The sanitary cleaning arrangement for knifes and sharp-edged objects in accordance with claim 1,
wherein the absorbent arrangement further comprises a protective layer covering at least a portion of the sanitizing agent supply surfaces of the first absorbent module and second absorbent module.

4. The sanitary cleaning arrangement for knifes and sharp edged objects in accordance with claim 3,
wherein the protective layer has a perforated configuration for allowing the release of sanitizing agent through the protective layer.

5. A knife sheath assembly comprising a receptacle sheath member for holding knifes and sharp-edged objects and a sanitary cleaning arrangement in accordance with claim 1,
wherein the receptacle sheath member defines a housing for supportive accommodation of the absorbent arrangement in the installation position.

6. A knife sheath assembly in accordance with claim 5, comprising a scraper device for wiping off the knife blade when moving the knife blade into and away from the cleaning position.

7. A knife sheath assembly in accordance with claim 5, wherein the knife sheath assembly further comprises
a lid member which is releasably attached to the receptacle sheath member and being arranged with a knife opening for inserting the knife blade into the cleaning position.

8. A knife sheath assembly in accordance with claim 6, wherein the scraper device is accommodated in the lid member and configured for engagement with the knife blade when entering through the knife opening.

9. A knife sheath assembly in accordance with claim 5, further comprising an attachment piece for selective suspension of the receptacle sheath member from a user.

10. Method for sanitary cleaning knifes and sharp edged objects by means of an absorbent arrangement comprising a first and a second absorbent module moisturized with a sanitizing agent, wherein the first and the second absorbent module are accommodated in an installation position by a knife sheath assembly, where the sanitizing agent supply surfaces of the first and the second absorbent module are positioned opposed facing each other, wherein the method comprises the following steps:
guiding a first portion of the blade of a knife or a sharp-edged objects into an insert area of the absorbent arrangement,
directing the knife blade further into the insert area and receiving the knife blade in a cleaning position in between the sanitizing agent supply surfaces thereby applying the sanitizing agent released from the sanitizing agent supply surfaces of the first and a second absorbent module onto the knife blade.
